(19) United States
(12) Patent Application Publication
(10) Pub. No.: US 2018/0106052 A1
(43) Pub. Date: Apr. 19, 2018

(54) DUTCHY WITH INTEGRATED PRESSURE INDICATOR

(71) Applicant: Stouffville Glass Inc., Stouffville (CA)

(72) Inventor: Norman Koster, Stouffville (CA)

(21) Appl. No.: 15/783,092

(22) Filed: Oct. 13, 2017

(30) Foreign Application Priority Data
Oct. 14, 2016 (CA) 2945338

(51) Int. Cl. E04F 21/28; E06B 3/54; E04B 2/88

(52) U.S. Cl. CPC E04F 21/28; E04B 2/88; E06B 3/54

(57) ABSTRACT

A dutchy for fastening to a frame, to secure at least one glass pane or panel against the frame, comprises opposed wings adjoined by at least one resilient web disposed substantially within a plane containing a line of flexure along which the at least one web bends. Each wing comprises at least an intermediate portion spaced from the frame, at least one foot for bearing against the glass pane, and at least one raised portion projecting forwardly beyond the front face of the web. A bearing surface for engagement by a fastener is disposed between the respective feet of the opposed wings. The raised portions of the wings are spaced apart along the line of flexure, such that when a force is applied to the bearing surface the web flexes elastically toward the frame, causing the opposed raised portions to move toward each other in proportion to the amount of the applied force.

### CROSS-REFERENCE TO RELATED APPLICATION

This application claims priority to Canadian Patent Application No. 2,945,338 filed on Oct. 14, 2016.

### FIELD OF THE INVENTION

This invention relates to glass window panes or panels. In particular this application relates to a pressure plate or “dutchy” for temporarily holding a glass pane or panel in position after installation.

### BACKGROUND OF THE INVENTION

Glass panes or panels form an important part of a building, contributing to aesthetics, weather-proofing and ambient light within the structure during the daytime.

In a conventional building structure, the building frame provides a mullion to which large glass panes or panels, often two or more panes overlaying one another and separated along their edges by spacers, are mounted using a sealant such as silicone to secure the panes in place. As is well known, the mullion has a raised channel extending generally centrally along the length of its front face, which channel may have ribbed internal side walls adapted to threadedly receive a screw. A window frame is formed by mullions that bound the four sides of the glass pane or panel known as a capped system, within the bounds of the raised channels. The windows are installed by applying a bead of silicone to the portions of the mullion faces ‘inside’ the channel, about the entirety of the mullion frame, and a glass pane or panel is mounted to the faces of the mullions to adhere to the silicone sealant. Sometimes a window frame may only have one, two or only three sides of exterior raised channels or pressure plates and the other sides simply installed with silicone sealant.

Once the glass panes or panels have been mounted to both sides of the mullion channel, a temporary holding block known as a pressure plate or “dutchy” is screwed to the mullion channel overlapping the side edges of the glass or panels which abut the front face of the mullion, typically using a self-tapping metal screw. The dutchies are maintained in position until the silicone has cured, at which point the dutchies are removed and a finishing trim or exterior silicone seal is applied to the front faces of the mullions, concealing the channel and the edges of the window pane.

Current techniques utilize a dutchy, typically formed from aluminium and often cut from excess pieces of trim that will be used to finish the mullions after the silicone has cured. There are a number of problems associated with this practice.

First, aluminium dutchies are created for use on the construction site. This requires time to cut the plate from a larger piece of trim and drill a hole in the right place, generally centrally along the length of the plate, and sometimes re-drill the hole if the initial hole is not positioned correctly. Then a tape or gasket is applied to the surface of the dutchy that will contact the glass or panel, to protect from direct contact to the finished surface. This involves some amount of labour, and once the dutchies are removed they become irrecoverable scrap and are discarded, so the time spent creating the dutchies is ultimately wasted, as are the materials.

Further, there is no gauge indicating how tightly to fasten the screw holding the dutchy in place. If the screw is over-tightened the glass pane can crack, requiring significant time and cost to replace.

In some cases the dutchy undergoes deformation due to over-tightening of the screw. This reduces the force applied by the dutchy to the glass pane, creating a risk of dislodgement of the glass pane or panel or its separation from the face of the mullion. In either case this diminishes the structural integrity of the window and potentially requires reinstallation or replacement of the glass pane or panel.

Applying the correct amount of torque to the screw to transfer sufficient force to the glass pane, so as to hold the glass pane in place during the curing cycle without cracking the glass, is often merely the result of fortuitous guesswork. Even where this is achieved, when an aluminium dutchy undergoes plastic deformation under a wind load after installation the dutchy will not return to its original profile and therefore loses some of its fastening strength, potentially leading to the problems identified above.

It would accordingly be beneficial to provide a dutchy which overcomes some or all of the aforesaid problems.

### BRIEF DESCRIPTION OF THE DRAWINGS

In drawings which illustrate by way of example only a preferred embodiment of the invention,

FIG. 1 is an elevation of a building façade showing prior art dutchies temporarily securing glass panes to window mullions.

FIG. 2 is a plan view of a dutchy according to the invention.

FIG. 3 is a front perspective view of the dutchy of FIG. 2.

FIG. 4 is a rear perspective view of the dutchy of FIG. 2.

FIG. 5 is an end elevation of the dutchy of FIG. 2 in a relaxed condition prior to being installed to a mullion.

FIG. 6 is an end elevation of the dutchy of FIG. 2 in a compressed condition after being installed to a mullion.

### DETAILED DESCRIPTION OF THE INVENTION

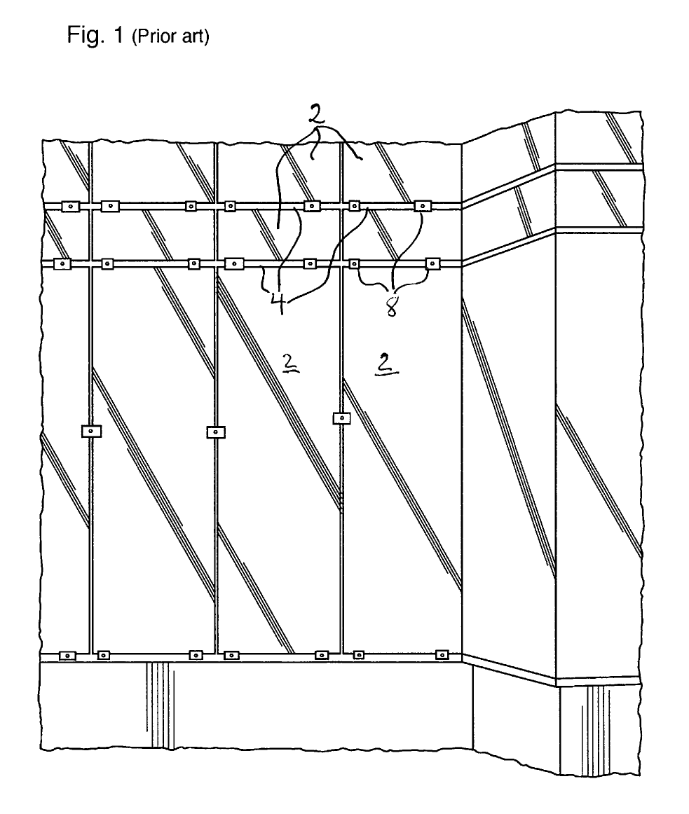

FIG. 1 illustrates prior art aluminium dutchies 8 temporarily securing glass panes 2 to the window mullions 4 of a building façade in accordance with the current practice. Each dutchy 8 is cut from an aluminium extrusion, for example extra strips of the trim that will be used to finish the mullions, and screwed to the window mullions 4 through a hole drilled generally centrally along the length of the dutchy. A tape or gasket (not shown) is applied to the rear surface of the dutchy 8, i.e. the surface in contact with the glass panes 2, to protect the glass or panel.

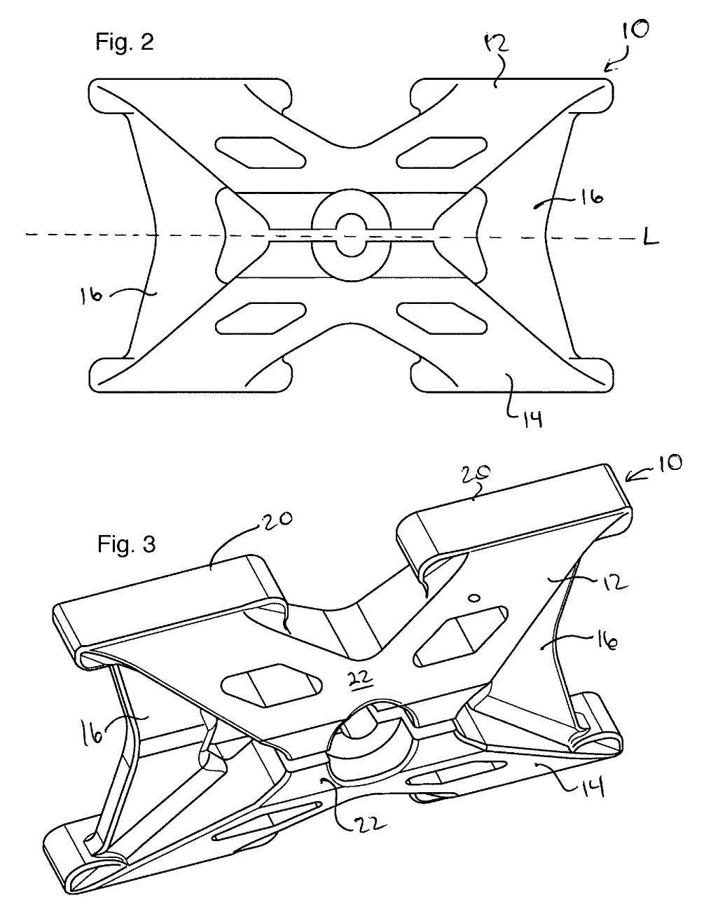

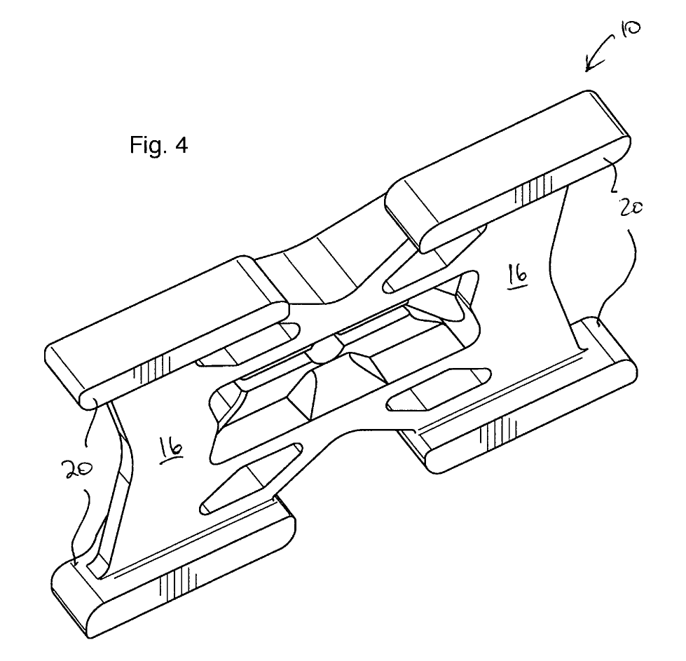

A dutchy 10 according to the invention, for fastening to a frame to secure at least one glass pane or panel against the frame, is illustrated in FIGS. 2 to 6.

The dutchy 10 is formed from opposed wings 12, 14 adjoined by at least one flexible web 16. The dutchy 10 in the embodiment illustrated has two webs 16, one adjoining the wings 12, 14 at each end of the dutchy 10. In some embodiments the webs 16 are formed from plastic, for example polycarbonate which has the strength to flex without plastic deformation under the pressures required to effectively hold a glass pane or panel in position for the required amount of time, and the durability to withstand harsh weather conditions and a wide temperature range. In embodiments in which the wings are formed from plastic the entire dutchy may be formed from plastic, for example (without limitation) injection molded, due to the expedience and lower cost of forming the dutchy from a single material in a single step. However, it will be appreciated that since the only portion of the dutchy that needs to be flexible are the webs, rigid materials may be used for other components of the dutchy and the manufacturing techniques used may be adjusted accordingly.

The webs 16 are disposed substantially within a plane containing a line of flexure L (shown in FIG. 2) along which each web 16 bends when the dutchy is compressed during mounting. The webs 16 extend between the wings 12, 14 and are adjoined (preferably formed integrally during the molding process) with each wing 12, 14 to hold the wings 12, 14 in a spaced apart position as described below.

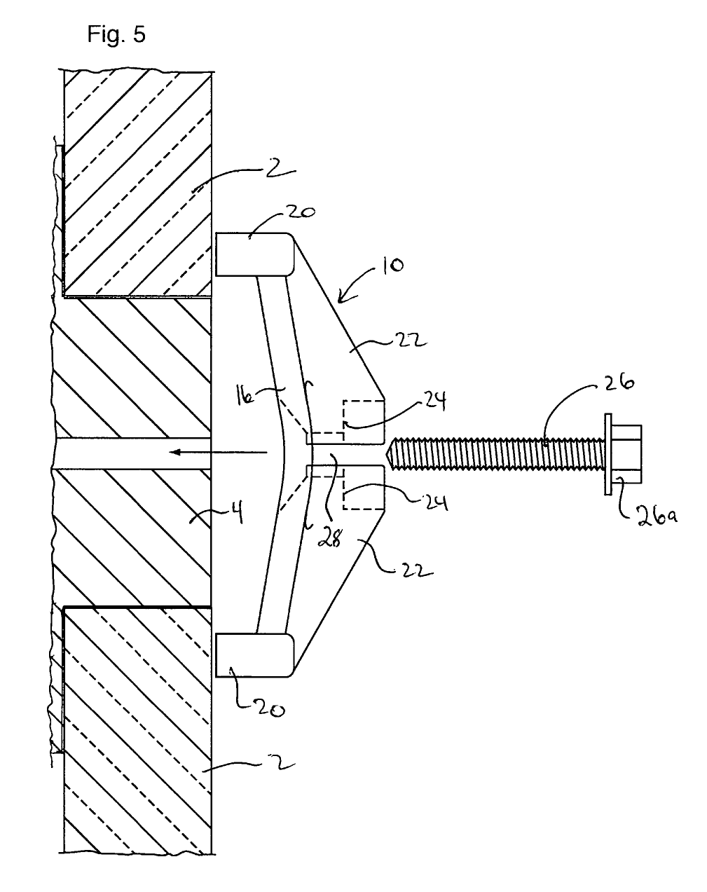

Each web 16 may be formed with a slightly curvate profile, so as to arch slightly forwardly as best seen in FIG. 5, which spaces an intermediate portion of the web 16 from the frame formed by the window mullions 4 (allowing room for the web 16 to flex toward the frame), and offers slightly greater compressive strength when the dutchy 10 is mounted. Each wing 12, 14 may optionally comprise one or more feet 20 for bearing against the glass pane or panel 2 when the dutchy 10 is mounted. In the embodiment shown the feet 20 project rearwardly beyond the rear faces of the webs 16, further spacing the webs 16 from the frame formed by the window mullions 4.

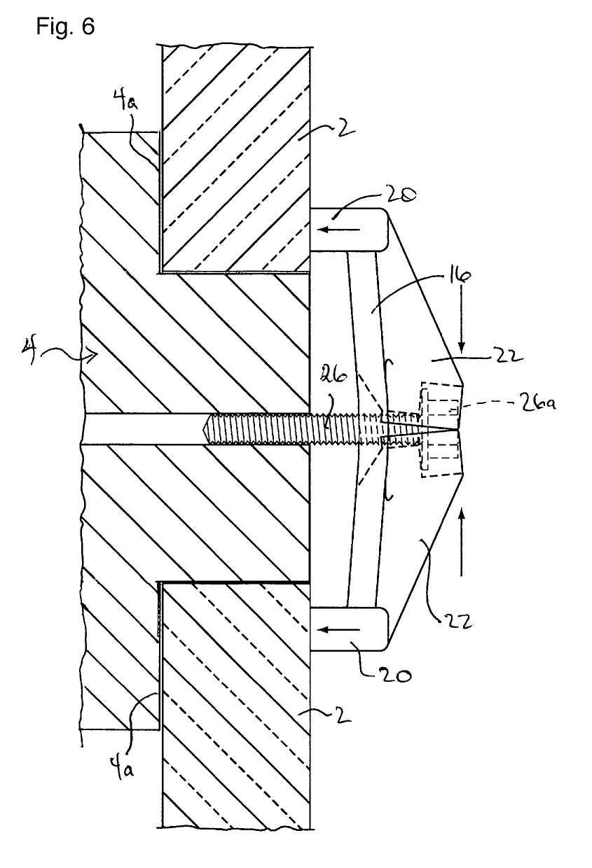

Each wing 12, 14 further comprises at least one raised portion 22 projecting forwardly beyond the front faces of the webs 16. The raised portions 22, best seen in FIGS. 5 and 6, are disposed on either side of the line of flexure L and spaced apart by a predetermined distance when the dutchy 10 is in the rest or unloaded condition, as at 28 in FIG. 5.

The opposed raised portions 22 of the wings 12, 14 are thus spaced apart along the line of flexure L. The raised portions 22 each provide a bearing surface 24 for engagement by at least one fastener 26, disposed at a position between the respective feet 20 of the opposed wings 12, 14, preferably generally centrally as shown. In the embodiment shown the bearing surfaces 24 bound the space 28 generally centrally along the length of the dutchy 10, as can be seen in FIG. 2.

When a force is applied to the bearing surfaces 24, the webs 16 flex toward the frame formed by the mullions 4. Thus, in use, when the self-tapping metal screw 26 is disposed through the space 28 at the compression point represented by the bearing surfaces 24, as the screw 26 is set into the mullion 4 the head 26a of the screw contacts the bearing surfaces 24. Further rotation of the screw 26 to drive it into the mullion 4 causes the opposed raised portions 22 to move toward each other in proportion to the amount of the applied force. In the preferred embodiment the space 28 is designed to be a distance whereby when the raised portions 22 of the wings 12, 14 touch, the correct amount of compressive force is being applied to the dutchy 10 so as to securely hold the glass pane(s) 2 against the seat 4a of the window frame formed by the window mullions 4, as shown in FIG. 6.

To remove the dutchy 10, the screw 26 is rotated in the reverse direction to detach the dutchy 10 from the mullion 4.

Utilizing the dutchy 10 of the invention, if a glass pane or panel 2 under the influence of a wind load causes the dutchy 10 to deform, the deformation is elastic so the dutchy 10 will recover as soon as the wind load dissipates, and none of the fastening strength of the dutchy 10 is lost.

A bight or annulus (not shown) may be provided through any convenient portion of the dutchy 10, or affixed to the dutchy 10 (for example by a web formed when molding the dutchy 10), to hold the screw 26. This facilities installation and removal by ensuring the screw is immediately available when the dutchy 10 is installed, and by providing a place to stow the screw when the dutchy 10 is demounted.

It is also possible to embed electrodes (not shown) at a selected point along the upper ridges of each raised portion 22 along the space 28, serving as a switch in a circuit with a small battery (or other power source such as a photovoltaic cell) and an LED which will illuminate when the electrodes touch to indicate when the correct amount of force has been applied to the dutchy and installation is complete.

Various embodiments of the present invention having been thus described in detail by way of example, it will be apparent to those skilled in the art that variations and modifications may be made without departing from the invention. The invention includes all such variations and modifications as fall within the scope of the appended claims.

1. A dutchy for fastening to a frame, to secure at least one glass pane or panel against the frame, comprising
opposed wings adjoined by at least one resilient web, the web comprising a rear face and a front face and being disposed substantially within a plane containing a line of flexure along which the at least one web bends, each wing comprising
at least an intermediate portion spaced from the frame,
at least one foot for bearing against the glass pane or panel, and
at least one raised portion projecting forwardly beyond the front face of the web, and
a bearing surface for engagement by at least one fastener disposed between the respective feet of the opposed wings,
the opposed raised portions of the wings being spaced apart along the line of flexure such that when a force is applied to the bearing surface the web flexes elastically toward the frame, causing the opposed raised portions to move toward each other in proportion to the amount of the applied force.
